(19) United States
(12) Patent Application Publication
(10) Pub. No.: US 2008/0142320 A1
(43) Pub. Date: Jun. 19, 2008

(54) TOROIDAL ROTARY DAMPER APPARATUS

(76) Inventor: Norick B. Moradian, Berkeley, CA (US)

Correspondence Address: LAW OFFICES OF CHARLES L. THOEMING;BIELEN, LAMPE & THOEMING, P.A., TWO CORPORATE CENTRE 1390 WILLOW PASS ROAD, SUITE 1020, CONCORD, CA, 94520, US

(21) Appl. No.: 11/610,352

(22) Filed: Dec. 13, 2006

(51) Int. Cl. F16F 9/53

(52) U.S. Cl. 188/267.2

(57) ABSTRACT

A damper apparatus includes a housing having a toroidal inner housing surface and a slidably linked piston moveable in the housing having a curved outer peripheral piston surface in engagement with the inner housing surface. A fluid barrier is attached to the housing and located in the housing interior. A flow control passageway and electro-magnetic field control valve defined by either the piston or the damper shaft/arm assembly controls viscosity and passage of magnetic-rheological damper fluid when there is relative rotational movement between the piston and the housing to dampen the forces causing relative rotational movement.

### CROSS REFERENCES TO RELATED APPLICATIONS

None.

### STATEMENT REGARDING FEDERALLY SPONSORED RESEARCH OR DEVELOPMENT

None.

### THE NAMES OR PARTIES TO A JOINT RESEARCH AGREEMENT

None.

### INCORPORATION-BY-REFERENCE OF MATERIAL SUBMITTED ON A COMPACT DISC

None.

### TECHNICAL FIELD

This application relates to damper apparatus for dampening a force, for example a force caused by relative movement between two structural elements operatively associated with the damper apparatus. More specifically, the rotary damper apparatus provides a disc-like circular piston with three-dimensional symmetrical force distribution between the piston and the connecting piston arm. Improved control valves provide application of the apparatus to magneto-rheological damper fluids.

### BACKGROUND OF THE INVENTION

Dampers are hydraulic devices used to restrict the number of cyclic oscillations caused by a deflection force; damping forces are generated by pumping fluid through regulating orifices, converting kinetic energy into laminar and turbulent friction. Two types of damping devices are currently in wide use; telescopic and rotary vane type. Traditional van type rotary dampers have inherent disadvantages, including the following:

1. Hysteresis, due to disproportionate vane and shaft seal pre-load friction; caused by means such as compression springs, Elastomers, band springs or Elastomer Composites, resulting in frictional losses and restricted dynamic range;

2. A rotary vane damper housing is subject to hoop stress, compression deformation and bending strain at vane junctions, causing excessive bypass flow and subsequent loss of compression; and

3. Thermal hysteresis due to non-uniform coefficient of expansion; exasperated by long linear sealing contours of the vane and structural components, leading to unpredictable sealing properties at higher temperatures and friction at lower temperatures. This limits the operating temperature range and diminishes the damping characteristics during thermal cycles. Furthermore, such prior art devices are hampered by their relative complexity, weight and high cost.

The following U.S. patents disclose rotary dampers believed to be representative of the current state of the prior art: U.S. Pat. No. 4,926,984, issued May 22, 1990, U.S. Pat. No. 5,577,761, issued Nov. 26, 1996, U.S. Pat. No. 5,324,065, issued Jun. 28, 1994, U.S. Pat. No. 4,886,149, issued Dec. 12, 1989, U.S. Pat. No. 5,400,878, issued Mar. 28, 1995, U.S. Pat. No. 5,381,877, issued Jan. 17, 1995, U.S. Pat. No. 6,296,090, issued Oct. 2, 2001, and U.S. Pat. No. 7,048,098, issued May 23, 2006.

Telescopic piston dampers are well known constructions employing a pressurized chamber or cylinder having a piston movable therein under controlled conditions and a piston rod associated therewith to provide the transfer of dampening force to the piston. These traditional-type dampers have certain fundamental drawbacks as well. In such devices, due to the fact that the piston rod passes through one end of the damper cylinder, there is a dynamic internal pressure differential caused by rod volume inclusion and exclusion as the damper rod enters and exits the cylinder, necessitating measures to counter internal volume imbalance by either pressurizing the opposing chamber by means of highly compressed gas and a dividing piston, as in a monotube gas design, or a secondary chamber, via a connecting valve known as a foot valve, as in the known doubletube design, or by addition of a complimentary dummy shaft on the opposing side to equalize internal volume. All of the above measures reduce damping efficiency, add cost, complexity and weight as well as require substantial space. Additionally, irregular internal pressure leads to localized fluid vaporization and creation of gas pockets in the fluid, known as cavitation, degrading damping efficiencies.

Since telescopic dampers, to conform to non-linear kinematic motion of the associate elements, are deployed predominantly with translational mechanisms, they can not be installed directly, or fixedly to a haul or a chassis. This curtails the thermal conductance capacity of the damper and of the fluid. Under severe operating conditions, fluid temperature can rise to well over 100 degrees C., resulting in reduction of fluid viscosity. Damping forces diminish exponentially due to fluid viscosity reduction, giving higher orifice discharge coefficient. Also, conventional translational or linear dampers have limitations when applied to long travel functions. It is difficult to accommodate a large travel due to the danger of bucking the damper shaft, especially at high relative velocities, the linear space claim required by the length of a linear damper can also create packaging problems.

Functionally, in order to achieve the desired damper force-velocity characteristics, it is very difficult to adjust the piston-valve; solutions such as a hollow piston rod containing an internal shaft that performs the adjustments being very costly and often incompatible with servo controls due to high torque demands. Piston embedded servo valves are also complex, as well as reducing the hydraulic capacity of the damper.

As described earlier, to adapt to non-linear and kinematic requirements of the damping structures, telescopic dampers are predominantly deployed via translational members and bushings, excluding the possibility of direct attachment of damper to the structures, hence impeding a heat transfer passage.

Rheological fluids exhibit flow characteristics which are altered in a controllable manner using electrical current or a magnetic field. Depending upon base fluid characteristics and the strength of the electrical or magnetic field, fluid viscosity can be modified from thinner-than-water to nearly-solid and any stage in between. The fluid response is in the order of milliseconds, completely reversible and extremely controllable.

Electro-rheological (ER) fluid changes viscosity when an electrical current is applied directly to the fluid itself. ER has been tested and applied to a wide range of applications, including dampers. A negative factor of ER fluid, however, is its limited resistance to shearing movement, or shear strength.

ER and Magneto-rheological (“MR”) fluids have many similarities. Both can use oil, silicone, water or glycol as the base fluid, and both contain polarizable particles suspended in the fluid. Polarizable, in this context, means the particles can be forced to align in a uniform way. These suspended polarizable particles are the basic difference between ER and Mr fluids. MR fluid has a shear strength nearly ten times stronger than ER fluid. ER fluid uses particles that polarize when directly exposed to an electric field. MR fluid uses somewhat larger particles of iron that polarize when surrounded by a magnetic field.

Typical MR fluid particles are soft iron spheres measuring 3 to 5 microns (3 to 5 thousandths of a millimeter) in diameter. Depending upon that application, the fluid will be 10 to 40 percent saturated with the iron particles, and other additives can be used to control particle settling and mixing, fluid friction and fluid viscosity. Specific gravity is generally between 3 and 4; thus, a 55 gallon drum of MR fluid can weigh almost a full ton. MR fluids are developed specifically for the application. MR fluids have been developed for specific use in dampers.

MR fluid can be used for two different functions—shear control and valve control. Shear control applications control relative movement of adjacent parts, such as in torque converters, clutches and brakes. In valve control mode, MR fluid can be used in place of any kind of flow control valve, which suggests the most common automotive application, shock absorbers.

My U.S. Pat. No. 5,971,118, issued Oct. 26, 1999, discloses a motion dampening apparatus which includes a damper housing defining a curved damper housing interior for a fixed attachment to a first structural member and a curved damper element for a fixed attachment to a second structural member and movable within the curved damper housing interior along a curved path of movement.

My U.S. Pat. No. 7,048,098 B1, issued May 23, 2006, discloses a toroidal rotary damper apparatus which includes a housing having a toroidal inner housing surface and a piston movable in the housing having a curved outer peripheral piston surface in engagement with the inner housing surface. A fluid barrier is attached to the housing and located in the housing interior. A flow control passageway defined by either the piston or the fluid barrier controls passage of damper fluid when there is relative rotational movement between the piston and the housing to dampen the forces causing relative rotational movement.

While the prior art indicated above does not teach or suggest the combination of structural features disclosed and claimed herein, it demonstrates the viability of the novel concept of transition of a force-bearing piston within a radial or circular structure; it also teaches the importance of fixed attachment of a damper to its associate structural members resulting in a thermally conducting pathway between a damper and a structure, as well as eliminating the use of translational members and bushings from the damper mounting points, which are also a source of parasitic friction.

### DISCLOSURE OF INVENTION

The present invention relates to a toroidal rotary damper apparatus which has a number of advantages over prior art damper constructions. The toroidal rotary damper apparatus has superior sealing properties due to constant and uniform contact between a piston employed in the apparatus and the interior of a toroidal shaped housing. Due to symmetrical geometry of the piston and the surrounding arcous interior, the piston or the shaft seals do not require a pre-load force, this considerably reduces internal friction and hysteresis. The apparatus has a low internal static pressure and has a constant internal volume, eliminating the need for a high pressure gas chamber or secondary expansion chamber to compensate for an external rod.

The damping torque T generated by the toroidal rotary damper is determined by volume of fluid displaced per angle of rotation θ, times the pressure drop across the piston ΔP or:

T=πθΔPR²r²

where: θ=angle in radian, ΔP=pressure drop across the piston, R=radius of the toroid, and r=radius of the damper piston.

The following relation converts rotary to linear motion: x=2πRθ/360. The damping rate is determined by the rate of change of ΔP, or rate at which the damping fluid is allowed to pass from the pressurized chamber across the control orifices and valves. Additionally, over a 90 degree sweep, mean toroidal volume displacement is 5% larger, hence generating 5% more damping force, than the equivalent linear displacement.

Furthermore, behavior of conventional telescopic damper is well understood, comprehensive mathematical models and fluid-dynamic simulations have been developed to analyze the characteristics, since the toroidal rotary damper employs piston, valving and cylindrical configuration substantially similar to that of telescopic dampers, all relevant analysis are directly applicable to the toroidal rotary damper system, where linear motion is translated into rotary displacement.

A toroidal rotary damper constructed in accordance with the specification operates according to the following described operating principle. The apparatus has a wide dynamic damping range, approaching 340 degrees, as well as good thermal distribution due to a high rate of fluid circulation and good thermal stability due to efficient heat dissipation throughout the apparatus exterior. The apparatus does not posses any inherent stress points due to balanced load distribution of the piston surface area against the interior of the torus.

Further, the apparatus is relatively simple and low cost, also providing the advantages of full external adjustability during operation and ease of serviceability due to the modular construction thereof.

The damper apparatus is relatively compact and adapted for installation even in restricted locations. The apparatus can accept forces through a central shaft thereof or at locations on the housing thereof and still effectively and efficiently provide damping. The toroidal rotary damper may be configured either internally within a suspension or a structure, or attached via a lever arm or linkage. In addition the toroidal rotary damper has smaller space requirements, no exposed sealing surfaces and, therefore, more resistance to debris and damage from foreign objects and harsh environments.

The toroidal rotary damper apparatus includes a housing defining a housing interior for containing damper fluid. The housing interior at least partially is formed by a toroidal inner housing surface disposed about and spaced from an axis.

The apparatus includes a piston in the housing interior having a curved outer peripheral piston surface in substantially fluid-tight engagement with the toroidal inner housing surface, spaced from the axis and disposed along a common plane with said axis. The piston is relatively movable along the axis defined by the damper arm. The housing and the piston are relatively rotatably moveable about the axis.

A flow control passageway (or control valve) is defined by either the piston or the damper arm and shaft assembly for permitting controlled passage of damper fluid there through responsive to relative rotational movement between the piston and the housing to dampen forces applied to the toroidal rotary damper apparatus causing the relative rotational movement.

Control valves comprising electro-magnetic variable field strength generator control the viscosity of MR fluid passing through each flow control passageway, thus restricting the flow volume through the passageway. Accordingly, the damping characteristics of the toroidal damper can be altered according to the application of the variable magnetic field across the fluid channels, in response to operational requirements of the damper apparatus.

Since the thermal expansion coefficient of the fluid is larger than that of the metallic parts of the damper, in certain applications, a low-pressure gas chamber or bladder could be provisioned in the interior of the housing to absorb added fluid pressure caused by fluid thermal expansion, preventing formation of gas or vapor bubbles in the fluid and effectively functioning as a temperature compensation mechanism.

Blow-off valves may also be incorporated in the piston or the fluid channels to limit the maximum transient pressure at higher piston velocities, in order to avoid damage to the damper resulting from impulse forces.

Other features, advantages and objects will become apparent with reference to the following description and accompanying drawings.

### BRIEF DESCRIPTION OF DRAWINGS

FIG. 1 is a perspective view of the housing assembly of an embodiment of partial toroidal rotary damper apparatus;

FIG. 2 is a perspective view with a housing half member of the apparatus removed illustrating the interior structure of the apparatus, including a piston;

FIG. 3 is a cross-sectional view taken along the line A-A in FIG. 1;

FIG. 4 is an exploded, perspective view illustrating selected components of an embodiment of partial toroidal rotary damper apparatus;

FIG. 5 is an exploded perspective view of the housing assemblies for an embodiment of partial toroidal rotary damper apparatus depicting flow within a valve;

FIG. 6 is an enlarged perspective view of the piston, shaft and slidable linkage, damper arm assembly of an embodiment of partial toroidal rotary damper apparatus;

FIG. 7 is an exploded, perspective view illustrating the selected components of an embodiment of the partial toroidal rotary damper apparatus of FIG. 6;

FIG. 8 is an exploded, perspective view illustrating the selected components of a MR fluid control valve assembly for an embodiment of the partial toroidal rotary damper apparatus;

FIG. 9 is an exploded, perspective view illustrating selected components of an embodiment of the partial toroidal rotary damper apparatus comprising two MR fluid control valves;

FIG. 10 is a cross-sectional view of an assembled embodiment of partial toroidal rotary damper apparatus of FIG. 9 taken along the lines A-A;

FIG. 10A is a cross-sectional view of an assembled embodiment of partial toroidal rotary damper apparatus of FIG. 9 taken along the lines A-A depicting magnetic flux lines;

FIG. 11 is a perspective of control valve of an embodiment of partial toroidal rotary damper apparatus;

FIG. 12 is an exploded, partial perspective view of an embodiment of the partial toroidal rotary damper apparatus comprising a piston having two control valves for controlling damper fluid in the housing interior;

FIG. 13 is a cross-sectional view of an assembled embodiment of partial toroidal rotary damper apparatus of FIG. 12 taken along the lines A-A.

### MODES FOR CARRYING OUT THE INVENTION

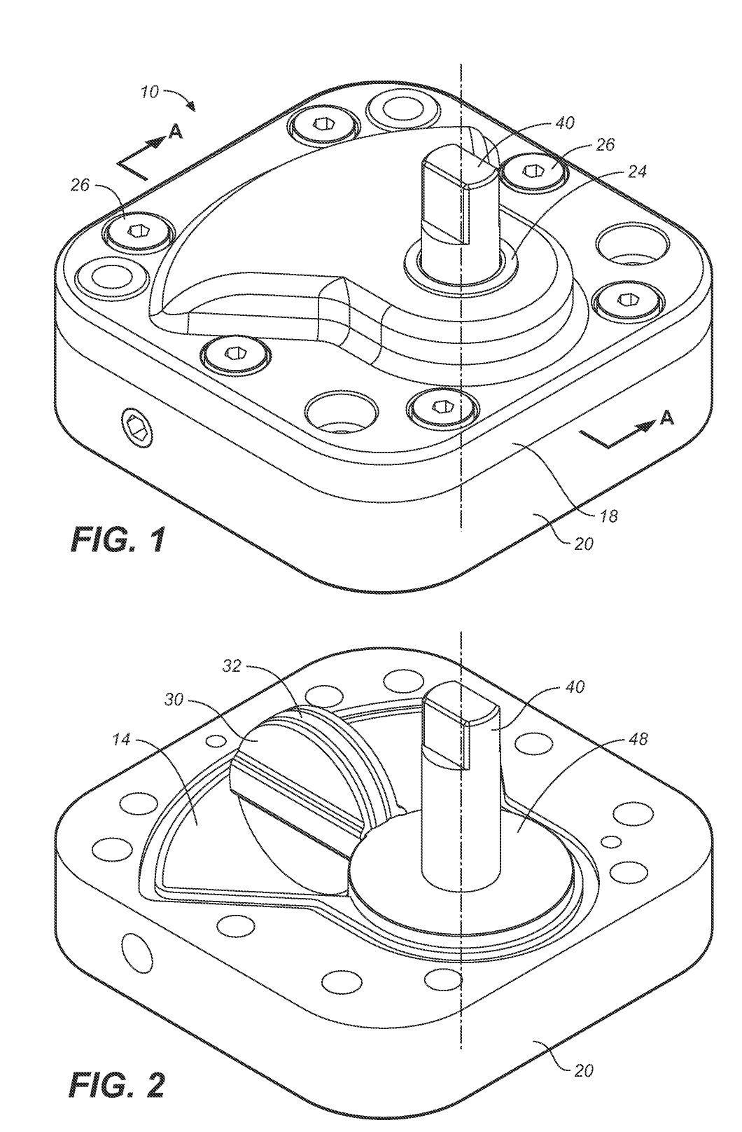

Referring now to FIGS. 1-4, a partial toroidal rotary damper apparatus is illustrated. The apparatus includes a housing 10 having terminal ends creating fluid barriers and defining a housing interior for containing damper fluid (not shown) of any conventional nature. The housing interior has a substantially circular cross section and is formed by a partial toroidal inner housing surface 14 disposed about and spaced from a central axis.

The housing 10 includes two adjoining housing half members, 18 and 20, each housing half member defining a portion of the housing interior and further defining openings respectively, at the central axis thereof. Threaded fasteners 26 extending through holes in outer flanges of the housing half members are utilized to releasably secure the housing half members together. The apparatus further comprises at least one control valve comprising means for magnetic field source within the housing interior and valve control for controlling operation of each control valve.

A piston 30 having a substantially circular-shaped outer peripheral piston surface at which is located an outer seal 32 is in substantially fluid-tight, slidable engagement with the toroidal inner housing surface 14, spaced from the central axis and disposed along a common plane with the central axis. The housing 10 and the piston 30 are relatively rotatably moveable about the central axis.

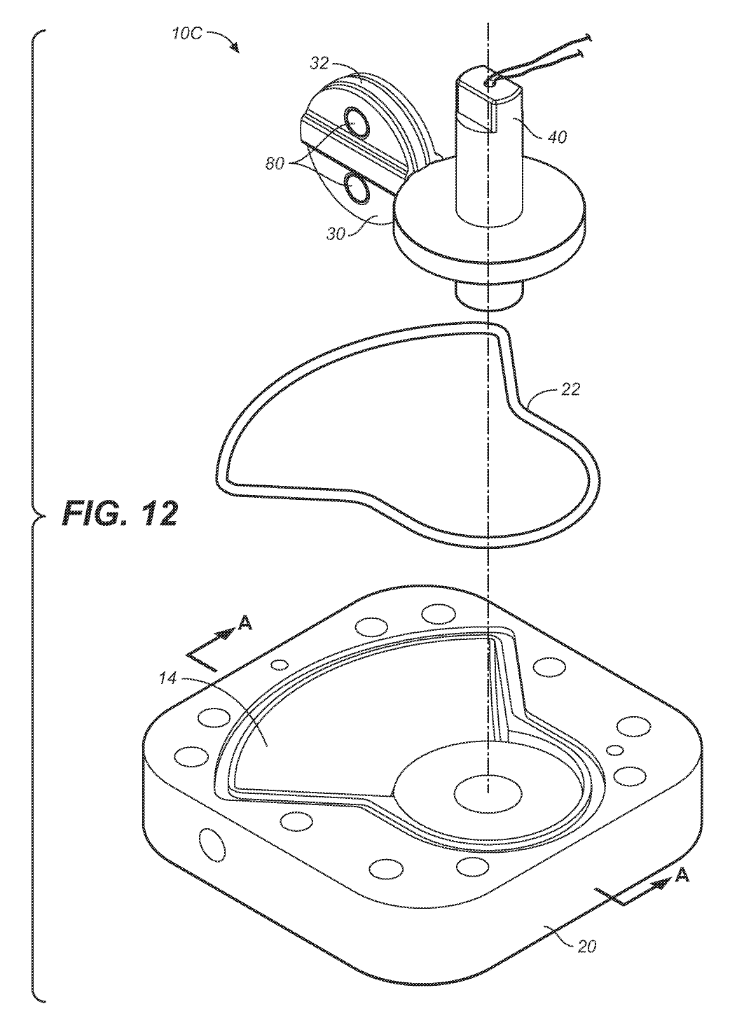

An embodiment of partial toroidal rotary damper apparatus provides a piston 30 which defines a fluid barrier and at least one flow control orifices or passageways 88 which permit restricted passage of damper fluid there through responsive to relative rotational movement between the piston 30 and the housing to dampen forces applied to the apparatus causing the relative rotational movement, FIGS. 11-13. Each passageway 88 is part of a control valve further comprising a cylindrical valve body 80 having a central longitudinal axis orthogonally disposed through the piston face, the body containing a valve bobbin 82 having solid ends with electromagnetic copper windings between bobbin ends, and a plurality of spacer lengths 86 between the body 80 and bobbin 82 aligning the bobbin 82 with the body longitudinal axis defining fluid passageways 88 through the piston face between the bobbin 82 and body 80.

A shaft 40 extends through the housing interior along the central axis and projects outwardly from opposed sides of the housing, the shaft passing through openings of the housing. A shaft end segment extends outwardly of each of the openings and is disposed outside the housing. In the arrangement illustrated, one end of the shaft 40 incorporates elongated, parallel flattened sides to facilitate connection of the shaft to other structure, if desired. The shaft is rotatable as a unit relative to the housing.

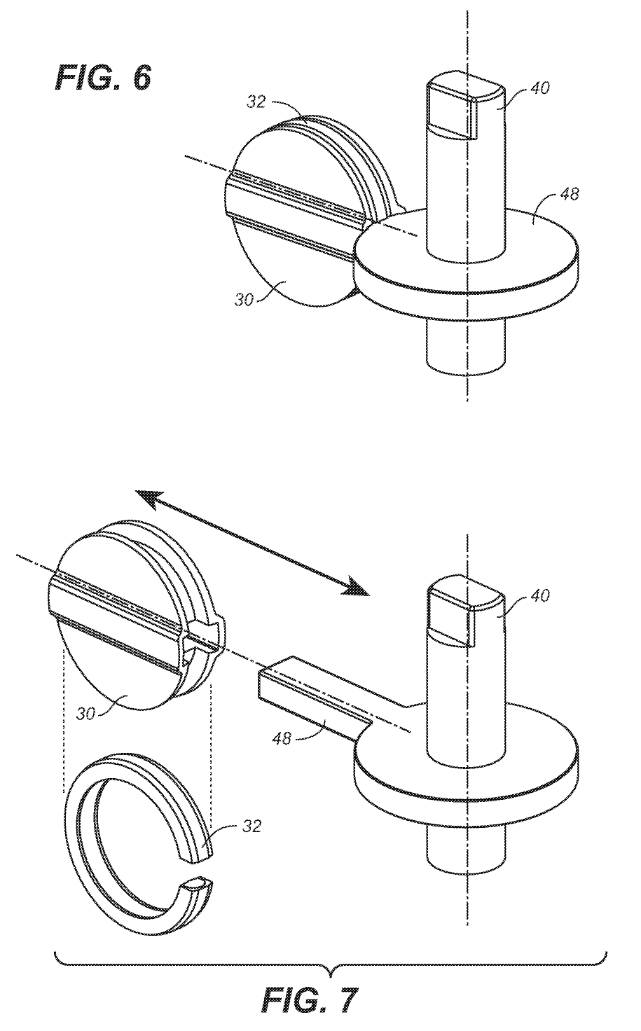

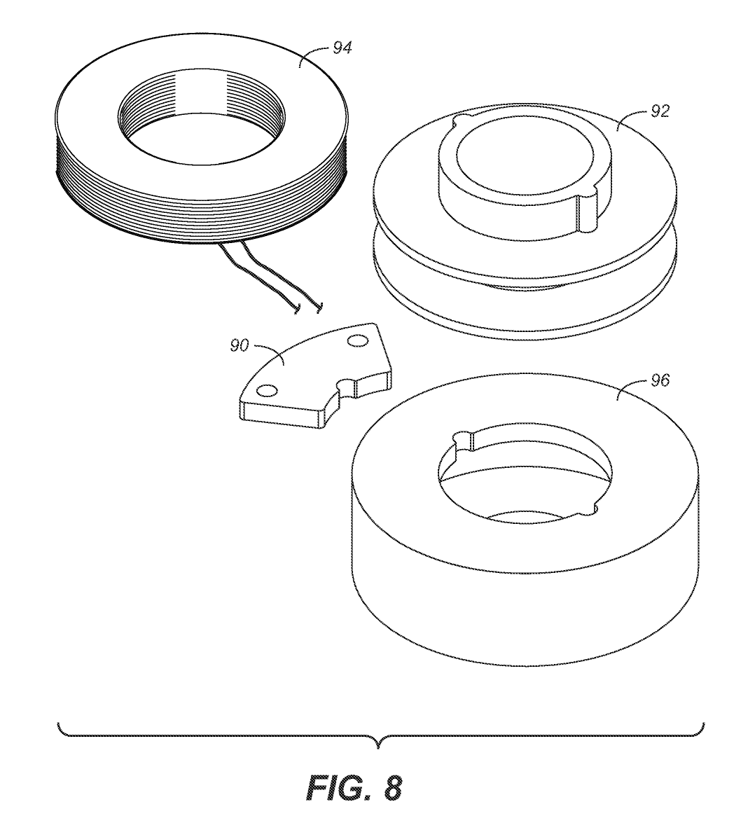

Piston 30 is secured to the shaft 40 by radially protruding damper arm member 48 affixed to the shaft 40. In the embodiment illustrated, sliding linkage assembly along the damper arm 48 allows the piston 30 to be relatively moveable along the damper arm and radial axis orthogonal to the central axis, FIGS. 6 and 7. The through-the-piston sliding linkage along the damper arm provides a three-dimensional, symmetrical force distribution path between the piston 30 and the damper arm member 48. This symmetrical union of the piston 30 and the damper arm member 48 uniformly transfers forces generated by internal fluid pressures to the damper arm member 48.

The through-the-piston sliding linkage along the damper arm member 48 eliminates mechanical fasteners and links to attach the piston 30 to the damper arm member 48. The assembly further provides more compact attachment by eliminating space claimed by external linkages and fasteners. The effective travel range of the damper arm member 48 is increased; and, thus, the effective damping range of the present invention from side to side is correspondingly increased.

Due to freedom of movement of the piston 30 along axis 34, known as one Degree of Freedom (DOF), afforded by the sliding connection between the piston 30 and the damper arm member 48, any minute variations in internal toroidal housing geometry due to manufacturing tolerances or misalignment of the housing halves, 18 and 20, are consequently self-adjusted and corrected by the sliding linkage assembly. Thus, possibility of collision between the piston 30 and the housing interior surface 14, and the resulting catastrophic damper failure, is eliminated.

Owing to the damper's principal function, conversion of kinetic energy into thermal energy, the damper housing is subject to thermal expansion and contraction, resulting in possible misalignment of the piston 30 and the housing interior surface 14. The sliding connection between the piston 30 and the damper arm member 48 will self-compensate for misalignment resulting from thermal anomalies, ensuring optimal alignment between the piston 30 and the toroidal housing interior surface 14 under varying thermal conditions.

The shaft 40 and piston 30 are jointly rotatably moveable about the central axis relative to the housing.

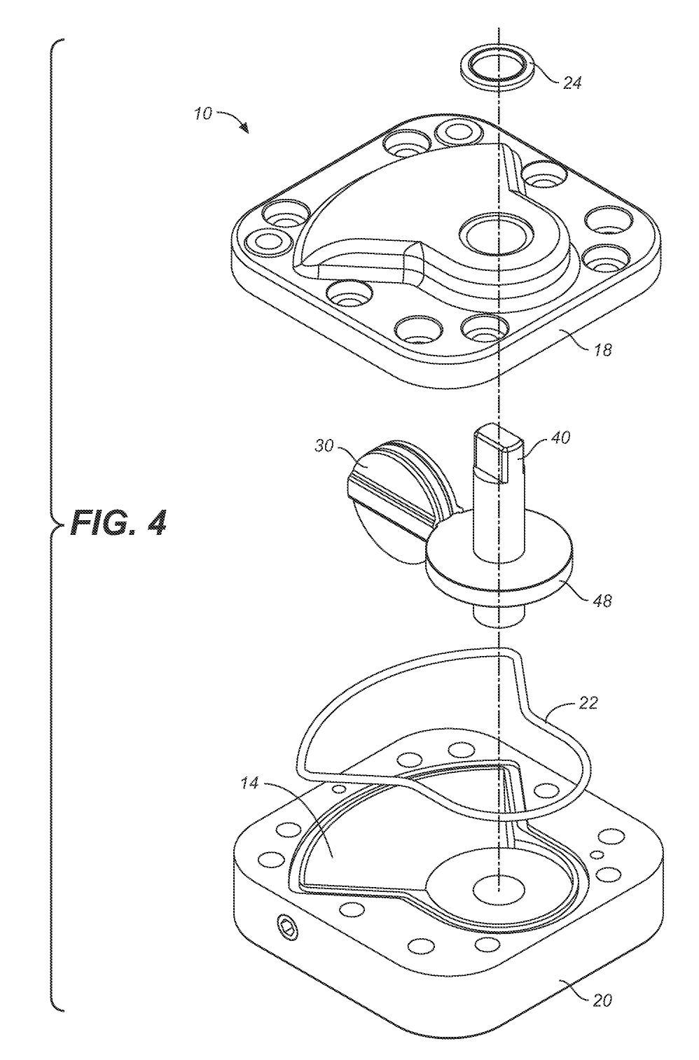

Relative rotational movement between the housing and the piston 30 about the central axis will cause pressurized damper fluid in the housing interior to pass through flow control passageways 88 or 98 and thus dampen forces resulting in the relative rotational movement, FIGS. 4, 5 and 11.

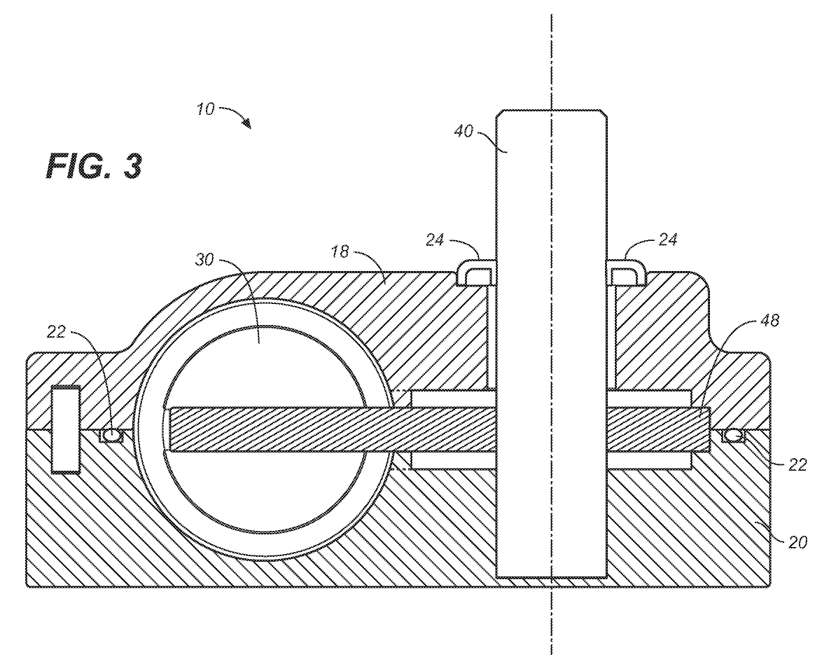

A number of seals are employed in the apparatus to prevent leakage of the pressurized damper fluid. A gasket seal 22 is installed in engagement with each of the housing half members at the point of the members' communication, FIGS. 3 and 4. A compression seal 24 surrounds the shaft and maintain pressurization of damper fluid within the housing interior.

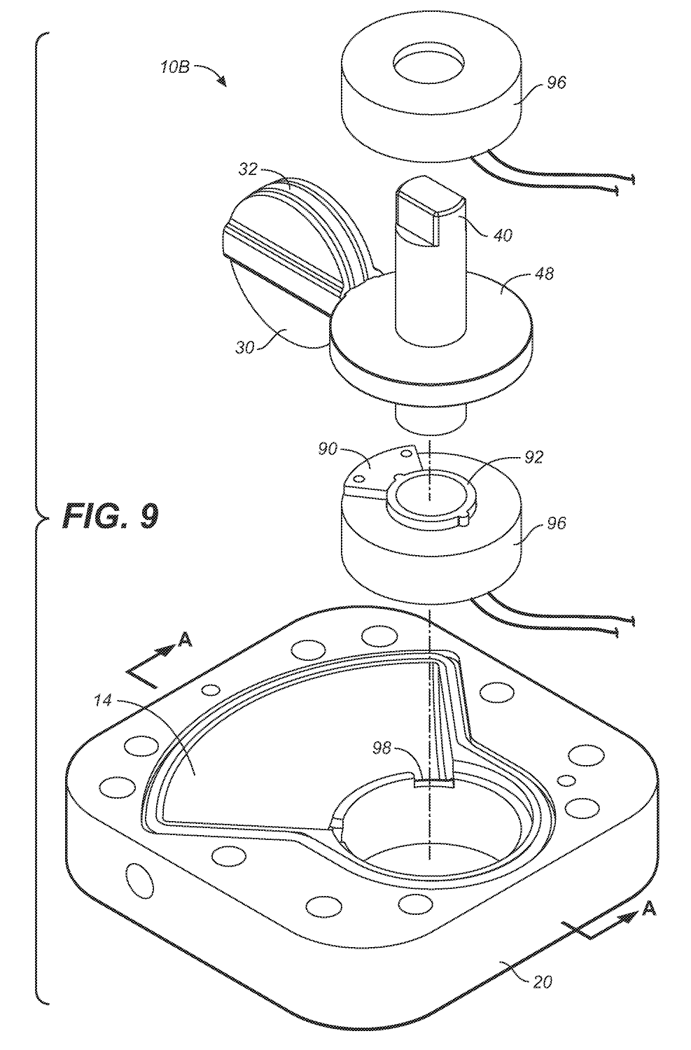

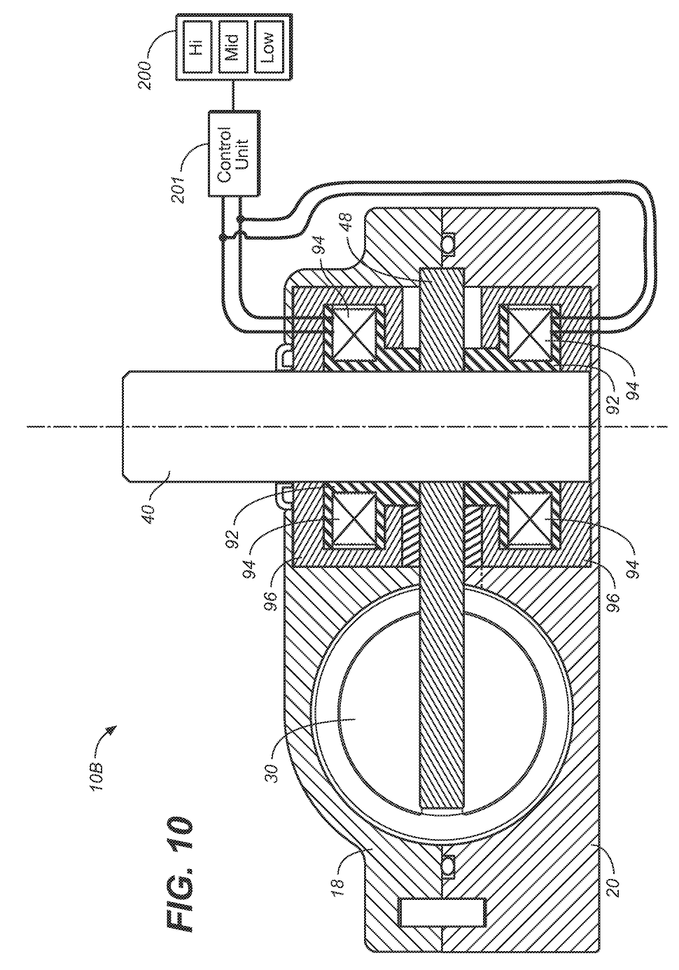

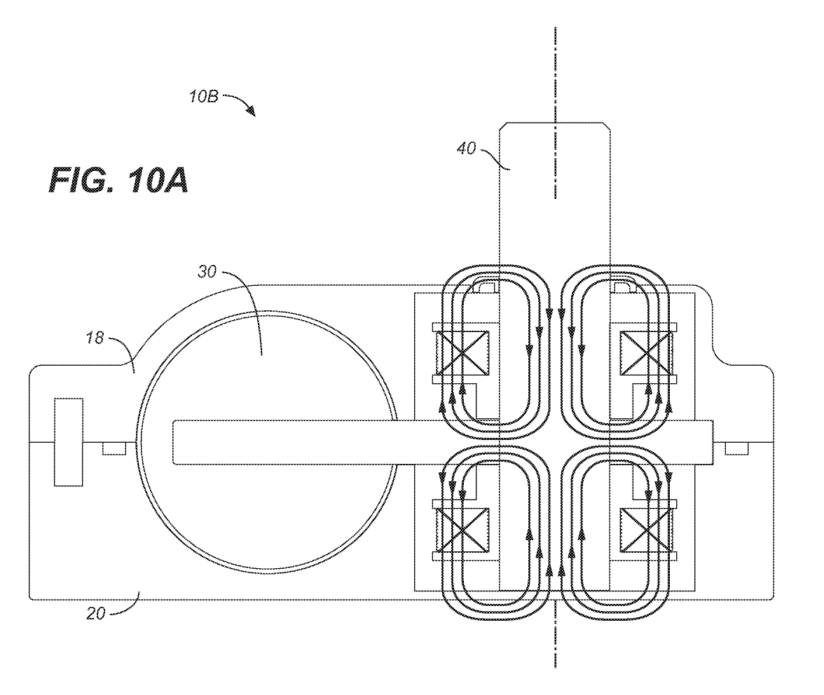

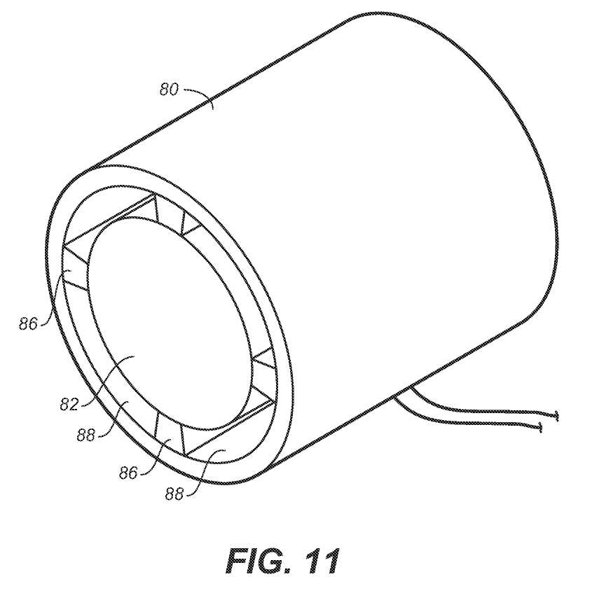

As discussed herein, MR fluids belong to a class of fluids that posses variable viscosity properties. When exposed to a magnetic field, the behavior of MR fluids reversibly and instantaneously change from a free-flowing liquid to that of a semi-solid with controllable yield strength. The toroidal damper apparatus of the present invention uses MR fluid in valve mode. In valve mode operation, a fluid orifice is subjected to a controlled magnetic field strength, controlling viscosity and, hence, the fluid volume passing through the orifice. Applicably, subjecting a fluid bypass orifice to a variable magnetic field strength varies the damping characteristics of the MR toroidal damper, FIGS. 9-10A. Because of the magnetic saturation limits of MR fluids, the magnetic field strength should be strictly monitored and applied to a controlled orifice region to avoid loss of MR fluid yield strength.

In order to effectively control the MR fluid characteristics, fluid must pass between two shaped poles of a magnet, subjecting the fluid to the maximum allowable number of magnetic flux lines. Referring to FIG. 10A, magnetic flux lines between the annular core and annular body restrict and control the volume or MR fluid passing in between the two surfaces, effectively acting as a fluid throttling valve. A traditional MR fluid valve is also used in an embodiment of the toroidal damper by placing one or more of such MR fluid valves in the piston 30, controlling passage of fluid volume from one side of the piston to the other, FIGS. 11-13.

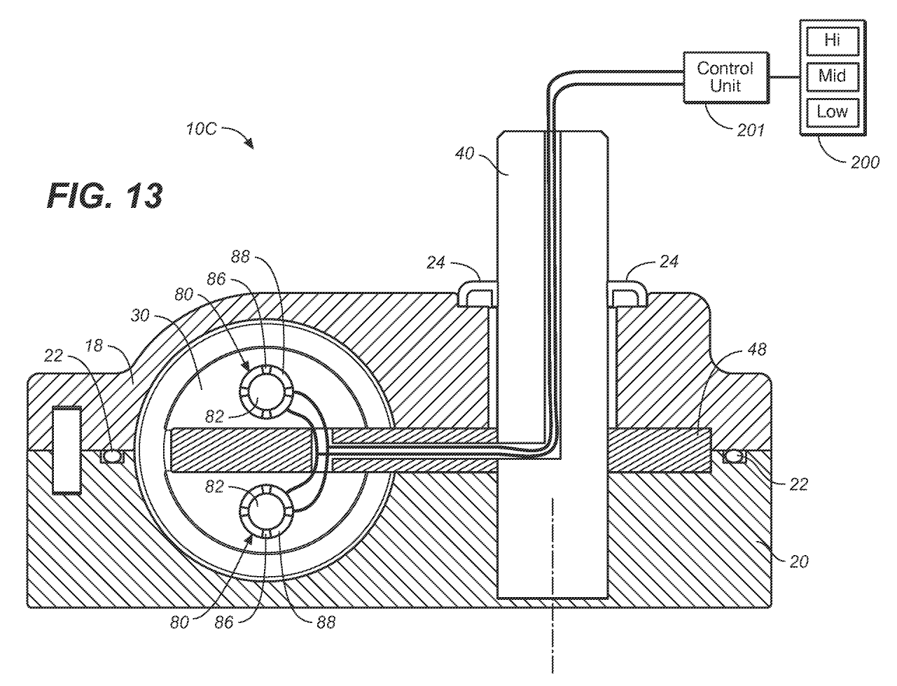

An example of a somewhat schematic presentation of a control system for the magnetic field strength source is depicted in FIGS. 10 and 13. The magnetic field strength source is operatively associated with a control unit or central processing unit 201 managed by discrete control strategies 200 adaptable during operation.

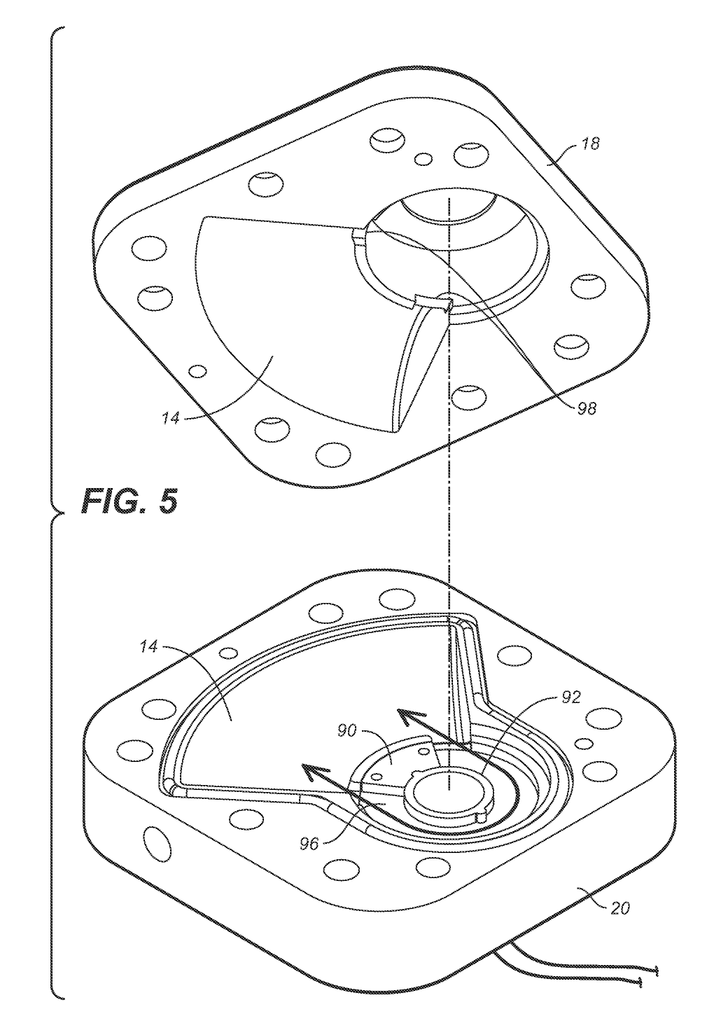

FIGS. 5, 8, and 9-10A illustrate embodiments of partial toroidal rotary damper apparatus wherein the housing interior accommodates a novel MR fluid flow control valve comprising a magnetic conducting member 96 disposed on the shaft 40 within a valve housing cavity, fluid channel openings 98 in the valve housing cavity at the housing terminal ends, copper winding 94 disposed between a dielectric bobbin 92 housed within the magnetic conducting member 96, and a dielectric spacer 90 disposed on the magnetic conducting member 96 proximal to the damper arm 48 and between fluid channel openings 98.

The novel MR fluid flow control valve uses the damper shaft 40 and the damper arm 48 as integral parts of the annular core members of the control valve. The damper shaft 40 directs magnetic flux lines into the damper arm 48, FIGS. 10 and 10A. The magnetic flux lines pass through the damper arm 48 surface and enter the upper valve surface 96, pass across the fluid channel path depicted in FIG. 5, and travel through magnetic conducting member 96 back into the damper shaft 40, via the sliding contact, thus compelling the magnetic flow circuit. The sliding contact between the shaft 40 and side of the valve housing cavity allows conduction of magnetic field flux lines back into the shaft, FIG. 10A, to complete the magnetic field flux cycle. Fluid passageways or channel openings 98 are configured adjacent to the damper arm 48 to direct the passage of MR fluid from one side of the damper, relative to the piston 30, to the other side, FIG. 5. These fluid passageways or channels form a circumferential fluid path around the circular portion of the damper arm 48 connected to the damper shaft 40.

MR fluid passing through the channels 98 and fluid path is subjected to a controlled magnetic field between the damper arm 48 surface and the valve surface adjacent to the arm, controlling MR fluid viscosity and flow volume traveling within the channels and path. Controlling the viscosity of the MR fluid passing through the valve channels and path changes the flow volume, hence altering the toroidal damping characteristics as desired. The dielectric spacer 90 placed on the valve surface next to the damper arm 48 between fluid passageways or channel openings 98 directs fluid flow across the channels and path through the magnetic field and prevents the MR fluid from bypassing the magnetic field.

The foregoing disclosure is sufficient to enable one having skill in the art to practice the invention without undue experimentation, and provides the best mode of practicing partial toroidal rotary damper apparatus presently contemplated by the inventor. While there is provided herein a full and complete disclosure of the preferred embodiments of partial toroidal rotary damper apparatus, it is not intended to limit the apparatus to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Accordingly, the proper scope of the partial toroidal rotary damper apparatus should be determined only by the broadest interpretation of the appended claims so as to encompass all such modifications as well as all relationships equivalent to those illustrated in the drawings and described in the specification.

I claim:

1. Damper apparatus comprising, in combination:
a partial toroidal housing comprising terminal ends creating fluid barriers and defining a housing interior for containing magneto-rheological damper fluid, the housing interior at least partially formed by a partial toroidal inner housing surface disposed about and spaced from an axis;
a piston in the housing interior, the piston comprising a curved outer peripheral piston surface in substantially fluid-tight engagement with the toroidal inner housing surface, the piston surface spaced from the axis and movably disposed along a common plane with the axis such that the piston and housing are relatively rotatably movable about the axis;
at least one flow control passageway permitting controlled passage of damper fluid there through responsive to rotational movement between the piston and the partial toroidal housing to dampen forces applied to the toroidal damper apparatus causing the relative rotational movement;
shaft co-axial with the axis extending through the housing interior along the axis orthogonal to the inner surface, the shaft including a radially outward protruding damper arm having a surface and disposed within the housing and further including sliding linkage assembly movably engaging the piston such that the piston is relatively movable along the damper arm, and the shaft and the piston being jointly rotatably movable about the axis relative to the housing; and
at least one control valve within the control passageway.

2. The damper apparatus according to claim 1 wherein each control valve is mounted on the piston for selective flow control responsive to relative rotational movement between the piston and the housing and defines at least one flow control passageway.

3. The damper apparatus according to claim 2 further comprising a valve control for controlling operation of each control valve.

4. The damper apparatus according to claim 3 wherein each control valve further comprises means for magnetic field source.

5. The damper apparatus according to claim 4 wherein each control valve further comprises a cylindrical valve body having a central longitudinal axis orthogonally disposed through the piston face, the body containing a valve bobbin having solid ends with electromagnetic copper windings between bobbin ends, and a plurality of spacer lengths between the body and bobbin aligning the bobbin with the body longitudinal axis defining fluid passageways through the piston face between the bobbin and body.

6. The damper apparatus according to claim 1 wherein the flow control passageway is defined by the shaft and damper arm, with at least one control valve mounted on the shaft for selectively regulating flow of damper fluid through at least one control passageway responsive to relative rotational movement between the piston and the housing.

7. The damper apparatus according to claim 6 further comprising a valve control for controlling operation of each control valve.

8. The damper apparatus according to claim 7 wherein each control valve further comprises means for magnetic field source.

9. The damper apparatus according to claim 8 wherein each control valve further comprises magnetic conducting members disposed on the shaft within a valve housing cavity having sides, fluid channel openings in the valve housing cavity at the housing terminal end, electromagnetic copper winding disposed between a dielectric bobbin housed between the magnetic conducting members, and a dielectric spacer disposed on the magnetic conducting member proximal to the damper arm and between fluid channel openings.

10. The damper apparatus according to claim 9 wherein the shaft is in sliding contact with one side of the valve housing cavity.

11. The damper apparatus according to claim 10 wherein the shaft acts as a magnetic core, conducting magnetic field strength to the damper arm surface.

12. Damper apparatus comprising, in combination:
a partial toroidal housing comprising terminal ends creating fluid barriers and defining a housing interior for containing damper fluid, the housing interior at least partially formed by a partial toroidal inner housing surface disposed about and spaced from an axis;
a piston in the housing interior, the piston comprising a curved outer peripheral piston surface in substantially fluid tight engagement with the toroidal inner housing surface, the piston surface spaced from the axis and movably disposed along a common plane with the axis such that the piston and housing are relatively rotatably movable about the axis;
at least one flow control passageway permitting controlled passage of damper fluid there through responsive to rotational movement between the piston and the partial toroidal housing to dampen forces applied to the toroidal damper apparatus causing the relative rotational movement;
shaft co-axial with the axis extending through the housing interior along the axis orthogonal to the inner surface, the shaft including a radially outward protruding damper arm having a surface and disposed within the housing and further including sliding linkage assembly movably engaging the piston such that the piston is relatively movable along the damper arm, the shaft and the piston are jointly rotatably movable about the axis relative to the housing, and the shaft is in sliding contact with one side of the housing interior; and
at least one control valve within the control passageway.

13. Damper apparatus comprising, in combination:
a partial toroidal housing comprising terminal ends creating fluid barriers and defining a housing interior for containing magneto-rheological damper fluid, the housing interior at least partially formed by a partial toroidal inner housing surface disposed about and spaced from an axis;
a piston in the housing interior, the piston comprising a curved outer peripheral piston surface in substantially fluid tight engagement with the toroidal inner housing surface, the piston surface spaced from the axis and movably disposed along a common plane with the axis such that the piston and housing are relatively rotatably movable about the axis;
shaft co-axial with the axis extending through the housing interior along the axis orthogonal to the inner surface, the shaft including a radially outward protruding damper arm having a surface and disposed within the housing, the shaft and the piston being jointly rotatably movable about the axis relative to the housing; and
at least one control valve within the control passageway, each control valve comprising:
an electro-magnetic field strength;
valve control;
magnetic conducting members disposed on the shaft within a valve housing cavity having sides;
fluid channel openings in the valve housing cavity at the housing terminal ends defining a flow passageway around the shaft permitting controlled passage of damper fluid there through responsive to rotational movement between the piston and the partial toroidal housing to dampen forces applied to the toroidal damper apparatus causing the relative rotational movement;
copper winding disposed between a dielectric bobbin housed between the magnetic conducting members; and
a dielectric spacer disposed on the magnetic conducting member proximal to the damper arm and between fluid channel openings.

14. Damper apparatus of claim 13, further comprising sliding linkage assembly movably engaging the piston such that the piston is relatively movable along the damper arm.

15. Damper apparatus of claim 14, wherein the shaft is in sliding contact with one side of the valve housing cavity.

16. Damper apparatus of claim 15 wherein the shaft acts as a magnetic core, conducting magnetic field to the damper arm surface.
